(19) United States
(12) Patent Application Publication
(10) Pub. No.: US 2025/0355606 A1
(43) Pub. Date: Nov. 20, 2025

(54) NON-TRANSITORY COMPUTER READABLE STORAGE MEDIUM, SERVER, AND LABEL DATA SHARING SYSTEM

(71) Applicant: BROTHER KOGYO KABUSHIKI KAISHA, Nagoya (JP)

(72) Inventor: Ryoji Ban, Kiyosu (JP)

(21) Appl. No.: 19/281,512

(22) Filed: Jul. 25, 2025

Related U.S. Application Data
(63) Continuation of application No. PCT/JP2024/002788, filed on Jan. 30, 2024.

(30) Foreign Application Priority Data
Feb. 3, 2023 (JP) 2023-015622

(51) Int. Cl. G06F 3/12; B41J 3/407

(52) U.S. Cl. CPC G06F 3/1273; B41J 3/4075; G06F 3/1203

(57) ABSTRACT

A non-transitory computer readable storage medium stores a program configured to be executed by a server. The server is configured to access a points database storing held points for each user ID. The held points being points held by a user. The program includes instructions which, when executed by the server, cause a computer of the server to execute acquisition processing of acquiring a printing log, the print log being output from an information processing device in a case where the information processing device causes a label printer to print, the printing log including a user ID set in the information processing device and a length of a printed label.

### REFERENCE TO RELATED APPLICATIONS

This is a continuation application of International Application No. PCT/JP2024/002788 filed on Jan. 30, 2024, which claims priority from Japanese Patent Application No. 2023-015622 filed on Feb. 3, 2023. The entire contents of the aforementioned applications are incorporated herein by reference.

### BACKGROUND ART

In the related art, as a system for sharing content data, a system is known in which a server for storing content data is prepared on the Internet, content data is posted from a device of a user, that is, uploaded to the server, and the content data is downloaded to a device of another user. In such a system, in order to promote posting of content data, a user who has posted content data may be granted points available in the system.

In a points management system disclosed in a related art, when photograph data is uploaded from a PC of a user A to a WWW server, and the photograph data is purchased and downloaded from the WWW server by a PC of a user B, points corresponding to a purchase amount are added to the user B as the purchaser, and points corresponding to the data size of the photograph data are added to the user A as the poster when the photograph data is uploaded or downloaded.

In recent years, a system for sharing label data used for printing a label in a label printer has been studied. In such a system, points are granted to a user who has printed label data in addition to a user who has posted label data, thereby promoting the use of consumables related to the printing of the label. However, there is no mechanism for granting points to printing of label data.

A configuration of granting more points for a larger data size as in the technique disclosed in the related art is also conceivable. Unfortunately, the data size does not necessarily indicate the consumption amount of consumables. Therefore, another mechanism for determining points to be granted to printing of label data is desired.

### SUMMARY

A non-transitory computer readable storage medium storing a program configured to be executed by a server,
the server being configured to access a points database storing held points for each user ID,
the held points being points held by a user,
the program including instructions which, when executed by the server, cause a computer of the server to execute:
   acquisition processing of acquiring a printing log, the print log being output from an information processing device in a case where the information processing device causes a label printer to print, the printing log including a user ID set in the information processing device and a length of a printed label, and
in which the instructions further cause the computer of the server to execute:
   determination processing of determining obtained points such that points are easier to obtain for a longer label, based on the length of the label included in the printing log acquired in the acquisition processing, the obtained points being points to be granted by printing with the label printer; and
   addition processing of accessing the points database to add the obtained points determined in the determination processing to the held points corresponding to the user ID included in the read printing log.

### BRIEF DESCRIPTION OF DRAWINGS

FIG. 1 is a diagram schematically illustrating a label data sharing system.

FIG. 2 is a diagram illustrating an example of tape metrics information.

FIG. 3 is a diagram illustrating an example of a user database.

FIG. 4 is a diagram illustrating an example of a posted label database.

FIG. 5 is a diagram illustrating an example of a printing log database.

FIG. 6 is a sequence diagram illustrating an example of a procedure of post processing.

FIG. 7 is a sequence diagram illustrating an example of a procedure of download processing.

FIG. 8 is a sequence diagram illustrating an example of a procedure of printing processing.

FIG. 9 is a flowchart illustrating an example of a procedure of obtained points processing.

FIG. 10 is a flowchart illustrating an example of a procedure of poster points processing.

FIG. 11 is a flowchart illustrating an example of a procedure of notification processing.

FIG. 12 is a sequence diagram illustrating an example of a procedure of printing processing.

### DESCRIPTION

Hereinafter, embodiments embodying a label data sharing system will be described in detail with reference to the accompanying drawings. The present embodiment discloses a label data sharing system in which a server and a plurality of information processing devices are connected via a network to share label data used for printing a label in a label printer.

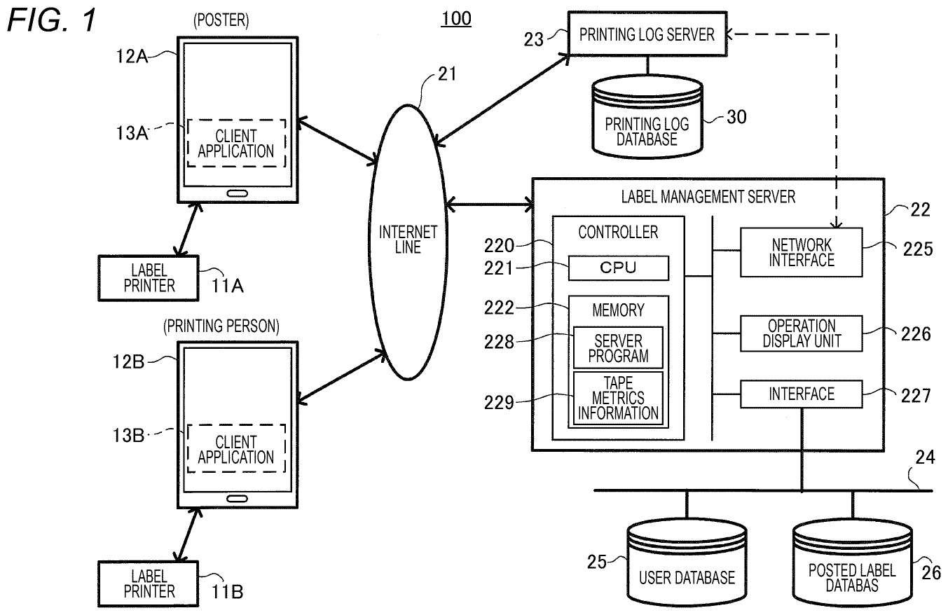

As illustrated in FIG. 1, a label data sharing system 100 (hereinafter abbreviated as “system 100”) according to the present embodiment is, for example, a system provided to a user by the vendor of the label printer. The system 100 includes a terminal 12A, a terminal 12B, and a label management server 22, which are connected via an Internet line 21. The terminals 12A and 12B are terminals owned by the owner or the user of the label printer. The terminals 12A and 12B can be connected to a printing log server 23 via the Internet line 21. The terminals 12A and 12B can be connected to label printers 11A and 11B, respectively. The label management server 22 can be connected to the printing log server 23.

The terminals 12A and 12B are information processing devices having a communication function, a display function, and an operation function. The terminals 12A and 12B according to the present embodiment are implemented with smartphones, and may be implemented with tablets or personal computers. The terminals 12A and 12B store client application programs (hereinafter referred to as “client applications”) 13A and 13B, respectively. The number of terminals connected to the label management server 22 is not limited to the present embodiment. In addition, the terminals 12A and 12B may be collectively referred to as a “terminal 12” if it is not particularly necessary to distinguish them. The client applications 13A and 13B may be collectively referred to as a “client application 13” if it is not particularly necessary to distinguish them. In addition, the label printers 11A and 11B may be collectively referred to as a “label printer 11” if it is not particularly necessary to distinguish them.

The client application 13 is an application program provided by the vendor of the label printer 11. The client application 13 has a function of creating and editing label data on the terminal 12. The client application 13 has a function of posting, that is, uploading, the created label data to the label management server 22. The client application 13 has a function of downloading label data from the label management server 22. The client application 13 has a function of printing the label data created on the terminal 12 and the downloaded label data using the label printer 11. The client application 13 has a function of outputting a printing log when the label printer 11 is caused to print a label.

The terminal 12A of the poster who posts the label data to the label management server 22 is an example of a “first information processing device”. The terminal 12B of the printing person who prints the label data using the label printer 11B is an example of a “second information processing device”. The label management server 22 is an example of a “server”. The Internet line 21 is an example of a “network”.

The label printer 11 is, for example, a printing device that includes a thermal transfer printhead and performs printing while unwinding a tape wound in a roll shape. For example, the label printer 11 prints an image on the accommodated tape and conveys the tape based on a print job received from the terminal 12, and causes the printed portion to protrude to the outside of the machine. A label having a predetermined label length and a predetermined label width is created with the tape protruding to the outside of the machine. The “label width” is a dimension in a direction orthogonal to a direction in which the label is conveyed out from the label printer 11, that is, a width direction. The “label length” is the length in the direction in which the label is conveyed out from the label printer 11, that is, the size in the length direction.

The label printer 11 is connected to the terminal 12 by wireless LAN communication such as Wi-Fi (registered trademark) or short-range wireless communication such as Bluetooth (registered trademark). The label printer 11 and the terminal 12 may be connected by wire using the USB communication standard.

There are a plurality of types of tapes usable in the label printer 11. For example, the type of the tape may be distinguished depending on the width of the tape, the color of the tape or the ink, or the material of the tape or the presence or absence of special processing. Models of label printers compatible with the tape are determined in advance depending on the type of the tape. The user can replace the label printer with a tape of a type suitable for the purpose or application among a plurality of types of tapes compatible with the model of the label printer to perform printing.

The label management server 22 is a device having at least a storage function and a communication function. The label management server 22 includes a controller 220 including a CPU 221 and a memory 222. The label management server 22 includes a network interface (hereinafter referred to as a “network IF”) 225, an operation display unit 226, and an interface 227, which are connected to the controller 220. The CPU 221 is an example of a “computer”. The controller 220 may be an example of a “computer”.

The CPU 221 is configured to execute various types of processing, in accordance with a program read from the memory 222 and based on a user's operation. The memory 222 is a storage area for storing various programs such as a server program 228 and various data such as tape metrics information 229. The memory 222 is used as a work area when executing various types of processing.

The server program 228 is a program for managing printing of labels by the label printer. The server program 228 has a function of accepting post of label data and transmitting the posted label data to the terminals. The server program 228 has a function of acquiring the printing log output from the terminal 12B of the printing person and granting points based on the label length of the printed label. The server program 228 is an example of a “program”. Functions of the server program 228 will be described later.

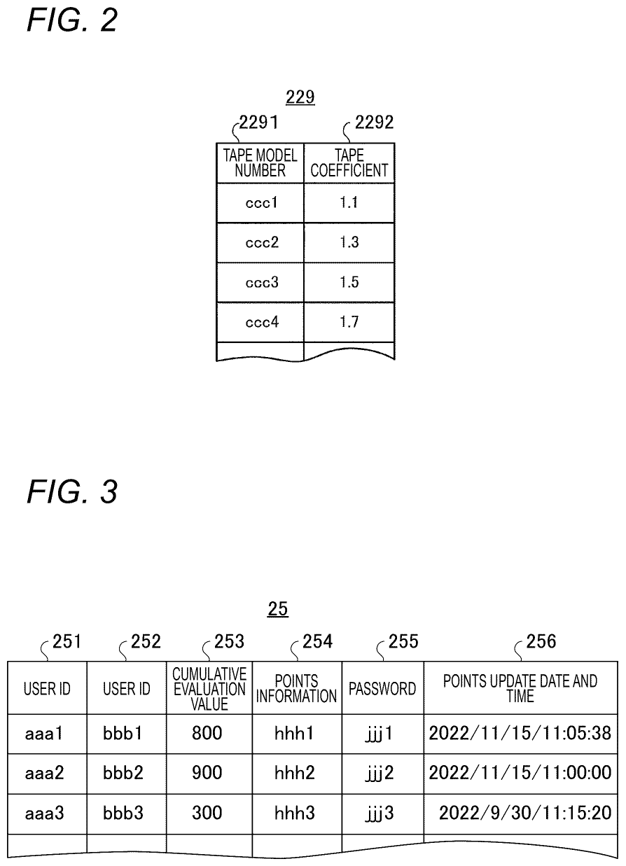

For example, as illustrated in FIG. 2, the tape metrics information 229 stores a tape coefficient 2292 in association with a tape model number 2291. The tape model number 2291 is information for identifying the type of the tape. The tape model number 2291 is assigned to each product, for example.

The tape coefficient 2292 is information indicating the value of the tape. The value of the tape varies depending on the type thereof. For example, a tape having a larger tape width is more valuable than a tape having a smaller tape width. For example, a tape having a special color of tape or ink, such as golden tape or ink, is more valuable than a tape having black and white tape and ink. For example, a tape made of a special material such as a cloth or a ribbon is more valuable than a tape made of a general-purpose material. Printing using a more valuable tape increases the printing cost. The tape coefficient 2292 is set to a higher value for a more valuable tape. The tape coefficient 2292 is used, for example, when granting points based on the label length.

Examples of the memory 222 illustrated in FIG. 1 are not limited to a ROM, a RAM, an HDD, and the like incorporated into the device, and may be a storage medium readable and writable by the CPU 221. The storage medium readable by the CPU 221 includes a recording medium such as a CD-ROM and a DVD-ROM in addition to the above examples.

The operation display unit 226 includes hardware configured to display a screen for notifying a user of information, and hardware configured to accept an operation from the user. The operation display unit 226 may be a touch panel having both a display function and an operation accepting function, or may be a set of a display having a display function and a keyboard, a mouse, a trackball, or the like having an operation accepting function.

The network IF 225 includes hardware for communicating with external devices such as the terminal 12 and the printing log server 23. Communication standards of the network IF 225 include Ethernet (registered trademark), Wi-Fi (registered trademark), and the like. The communication mode of the network IF 225 may be wired or wireless. The network IF 225 of the present embodiment is connected to the Internet line 21. The network IF 225 is connected to the printing log server 23 in a wired or wireless manner. The printing log server 23 is connected to a printing log database (hereinafter referred to as a “printing log DB”) and registers a printing log. The printing log DB 30 will be described later.

A user database (hereinafter referred to as “user DB”) 25 and a posted label database (hereinafter referred to as “posted label DB”) 26 are connected to the interface 227. In the present embodiment, the interface 227 is connected to the user DB 25 and the posted label DB 26 via a wired LAN 24. The user DB 25 and the posted label DB 26 may be included in the label management server 22 or may be included in a server different from the label management server 22. Alternatively, the user DB 25 and the posted label DB 26 may be included in different servers. The printing log DB 30 may be included in the label management server 22.

As illustrated in FIG. 3, the user DB 25 is configured to store held points for each user ID. The held points are points held by the user. The user DB 25 includes a record in which a user ID 251, a user name 252, a cumulative evaluation value 253, points information 254, a password 255, and a points update date and time 256 are associated with each other. The user DB 25 is an example of a “points database” and a “cumulative print amount database”.

The user ID 251 is identification information for identifying a user who can use the system 100, and specifies a user who uses the terminal 12. The user name 252 is a name, a nickname, an address, contact information, an e-mail address, or the like of an individual or an organization (corporation) of the user. The user ID 251 is newly set when the service provided by the system 100 is used for the first time. For example, when the service provided by the system 100 is used for the first time, the user name input by the user on the terminal 12 is additionally stored in the user name 252 of the user DB 25 so as to correspond to the new user ID 251.

The cumulative evaluation value 253 is information indicating the cumulative print amount or the label length. The cumulative evaluation value 253 stores a value obtained by accumulating evaluation values calculated based on the length of the label printed using the label printer. The cumulative evaluation value 253 includes an evaluation value based on a label length of a label printed using label data posted to the label management server 22 (hereinafter referred to as “posted label data”), and an evaluation value based on a label length of a label printed using label data not posted to the label management server 22 (hereinafter referred to as “original label data”).

The points information 254 is information indicating the held points of the user. The held points can be used instead of cash when, for example, purchasing a paid content or function, or consumables such as a tape, using the system 100. The held points are granted based on, for example, the label length of the printed label. The printed label may be a label based on the posted label data or a label based on the original label data. For example, points are added to the held points if the cumulative evaluation value exceeds a threshold.

The password 255 is a password set by each user stored in the user name 252. The points update date and time 256 stores the year/month/time when the points information 254, that is, the held points are updated. When the points information 253 is not updated and the cumulative evaluation value 253 is updated, the year/month/time when the cumulative evaluation value 253 is updated is stored as the points update date and time 256.

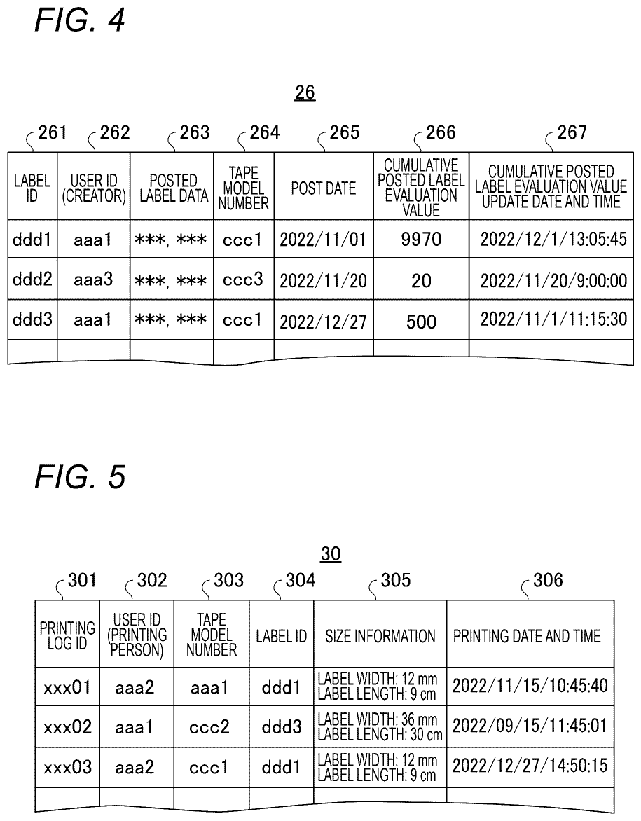

As illustrated in FIG. 4, the posted label DB 26 is configured to store the posted label data in association with the user ID. The posted label DB 26 includes a record in which a label ID 261, a user ID 262, posted label data 263, a tape model number 264, a post date 265, a cumulative posted label evaluation value 266, and a cumulative posted label evaluation value update date and time 267 are associated with each other.

The label ID 261 is a serial number sequentially assigned to each label data registered in the posted label DB 26 in the system 100 according to the present embodiment. The user ID (creator) 262 is a user ID 251 of a user who has posted using the system 100.

The posted label data 263 is label data posted to the label management server 22. The posted label data 263 includes information on various objects such as text, symbol mark, frame, image, and code information. The posted label data 263 includes information on various attributes such as label color, label length, and printing method.

The tape model number 264 is information for identifying the type of the tape. For example, the tape model number 264 stores the model number of the tape selected when the user posts the label data. The post date 265 is information indicating the date when the label data is posted.

The cumulative posted label evaluation value 266 stores a value obtained by accumulating the post evaluation values calculated based on the label length of the label printed based on the posted label data. Since the cumulative posted label evaluation value 266 is a value based on the length of the label printed based on the posted label data, the post evaluation value is also added by printing of a user other than the poster. The cumulative posted label evaluation value update date and time 267 is information indicating year/month/date/time when the cumulative posted label evaluation value 266 was last updated.

As illustrated in FIG. 5, the printing log DB 30 is configured to store a printing log output by the terminal 12. The printing log DB 30 includes a record in which a printing log ID 301, a user ID (printing person) 302, a tape model number 303, a label ID 304, size information 305, and a printing date and time 306 are associated with each other.

The printing log ID 301 is a serial number sequentially assigned to each printing log registered in the printing log DB 30. The user ID (printing person) 302 is the user ID 251 of a user who has printed a label by the label printer 11. The tape model number 303 is the model number of the tape used for printing the label. The information stored in the tape model number 303 may be information set when the label data is edited using the client application 13 or information acquired from the label printer 11 by the terminal 12.

The label ID 304 stores a label ID attached to label data printed by the label printer 11. When the printed label is a label based on posted label data, the label ID 261 of the posted label data is stored as the label ID 304. When the printed label is a label based on original label data, the label ID is not stored in the label ID 304.

The size information 305 is information indicating the size of the printed label. The size information 305 includes the label length and the label width of the printed label. The printing date and time 306 is information indicating the year/month/date/time when the label was printed by the label printer 11.

Next, the operation of the system 100 will be described. In the system 100, the posted label data is shared by posting the label data to the label management server 22 or transmitting the posted label data from the label management server 22 to the terminal 12. When the label data is printed by a label printer, the system 100 can determine points according to the label length of the printed label and add the points to the held points. The label data to be printed may be posted label data or original label data. Hereinafter, the post processing and the download processing will be described, and then the printing processing will be described.

Processing steps in the present embodiment basically indicate processing of the CPU 221 according to instructions mainly described in programs such as the server program 228. The processing by the CPU 221 also include hardware control using APIs of the OS. In the present specification, a detail description of the OS is omitted, and an operation of each program is described.

### (Post Processing)

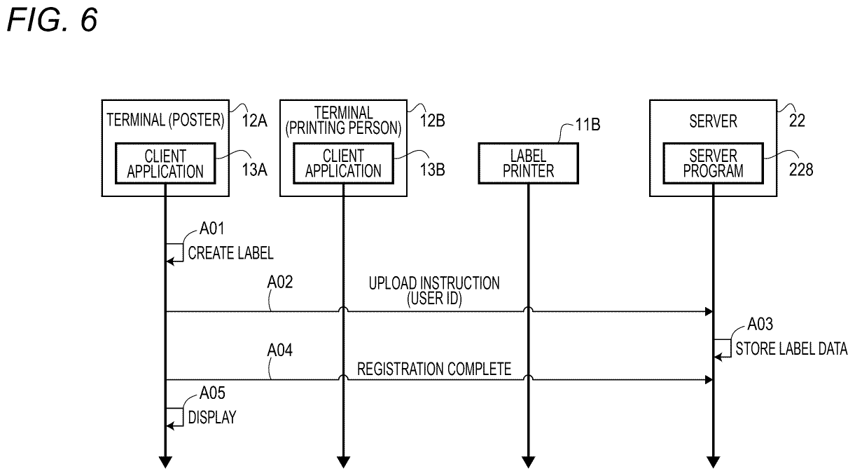

As illustrated in the sequence diagram of FIG. 6, in the post processing, a user who intends to post label data (hereinafter, referred to as a “poster”) activates the client application 13A of the terminal 12A and creates label data on the terminal 12A (A01). For example, upon accepting an instruction to create label data for posting, the terminal 12A displays a post screen (not illustrated) for creating label data. The terminal 12A accepts an operation of creating label data via the post screen and creates label data.

The post screen includes, for example, a “new post” button (not illustrated). The “new post” button is an operator for accepting an upload instruction. The “new post” button is associated with the address of the label management server 22. The upload instruction is an instruction to register the label data created by the poster in the label management server 22 in association with the user ID.

When the poster touches the “new post” button displayed on the terminal 12A, the client application 13A of the terminal 12A transmits an upload instruction and the user ID of the poster to the label management server 22 (A02).

An example of processing of transmitting the label data to the label management server 22 will be specifically described. For example, when the label management server 22 has a web server function, the terminal 12A displays a web page for posting provided from the server program 228 of the label management server 22 by the browser function of the client application 13A. The poster inputs the user ID when logging in to the label management server 22 via the web page. When authentication based on the input user ID is successful, the terminal 12A displays a post screen provided by the server program 228 by the browser function of the client application 13A, and accepts the label data. The post screen may accept the tape model number. The poster who has created the label data inputs the upload instruction via the web page by tapping the “new post” button. Thereby, the label data is uploaded to the label management server 22.

For example, when the client application 13A of the terminal 12A has a function of displaying the post screen, the client application 13A may accept an input of the user ID and the label data on the post screen. In this case, the terminal 12A attaches the user ID and the label data whose input has been accepted to the upload instruction to be transmitted to the label management server 22. When the tape model number is accepted on the post screen, the terminal 12A may further attach the tape model number to the upload instruction.

The label management server 22 accesses the posted label DB 26 using the interface 227 and stores the posted label data accepted via the terminal 12A (A03).

Specifically, the label management server 22 creates a new label ID as a new label ID 261, and provides a record including the new label ID in the posted label DB 26. Thereafter, for the record including the new label ID 261, the label management server 22 stores the received user ID 251 of the poster as the user ID (creator) 262, the received posted label data as the posted label data 263, and the year, month, and date of the post date and time as the post date 265. The process of A02 is an example of “upload acceptance processing” and “reception processing”. The process of A03 is an example of “storage processing”.

When the storage of the posted label data is complete, the label management server 22 notifies the terminal 12A of “registration complete” (A04). When receiving the notification of “registration complete”, the terminal 12A displays that, for example, the registration of the posted label is complete (A05). Accordingly, the poster can know that the posted label data has been registered in the system 100.

### (Download Processing)

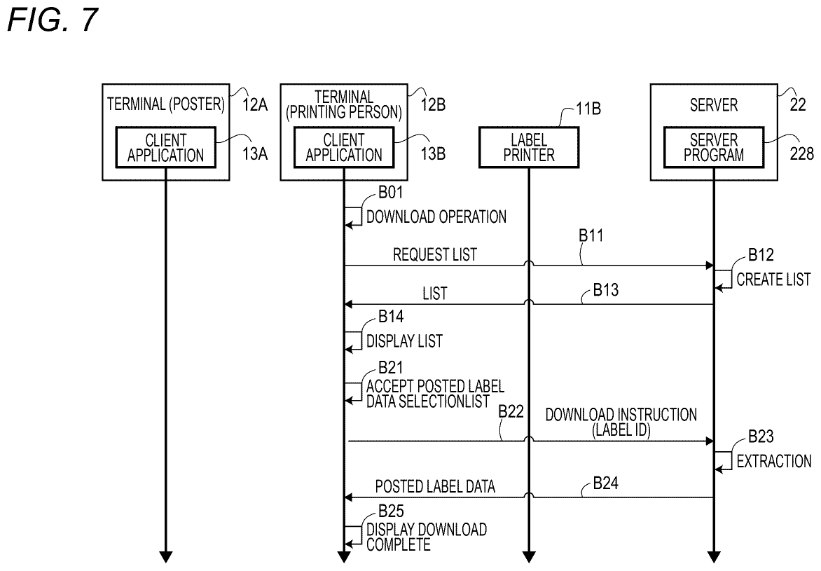

As illustrated in the sequence diagram of FIG. 7, in the download processing, first, a user who intends to download the posted label data (hereinafter, referred to as a “printing person”) activates the client application 13B of the terminal 12B, and then touches a “label download” button (not illustrated) displayed on the terminal 12B (B01). Then, the terminal 12B requests the label management server 22 to transmit a list of downloadable posted label data (B11).

For example, the server program 228 provides a login web page in the terminal 12B, and the terminal 12B displays the web page by the browser function of the client application 13B. By inputting the user ID via the web page, the user ID is transmitted from the terminal 12B to the label management server 22. When the login is approved, the label management server 22 accepts the list transmission request.

Upon accepting the list transmission request, the label management server 22 accesses the posted label DB 26 and creates a list based on the posted label data 263 that can be handled by the label printer (B12). At this time, when there are a plurality of pieces of posted label data 263 that can be handled by the label printer 11B, the label management server 22 can create a list based on the plurality of pieces of posted label data 263 and the label IDs 261. The posted label data 263 used at this time may be thumbnail image data of a label. Thereafter, the label management server 22 transmits the created list to the terminal 12B (B13). The list includes at least the image of the posted label data and the label ID.

Upon receiving the list, the terminal 12B displays a list of downloadable posted label data based on the received list. For example, the server program 228 provides a web page for selecting the posted label data, and the terminal 12B displays the web page by the browser function of the client application 13B (B14). The posted label data is displayed as a list via the web page.

The screen includes, for example, a selection button (not illustrated) for selecting the posted label data and an “execute” button (not illustrated) for executing the download. When the printing person selects one of the plurality of pieces of posted label data displayed on the terminal 12B and then touches the “execute” button, the terminal 12B accepts the selection of the posted label data to download (B21). Then, the terminal 12B transmits a download instruction to the label management server 22 (B22). The download instruction is an instruction for downloading the selected posted label data. The label ID of the selected posted label data is attached to the download instruction.

Upon receiving the download instruction (B22), the label management server 22 accesses the posted label DB 26 using the interface 227, and extracts the posted label data 263 corresponding to the label ID attached to the download instruction (B23). The label management server 22 transmits the extracted posted label data 263 to the terminal 12B (B24). The process of B22 is an example of “download acceptance processing”. The process of B24 is an example of “transmission processing”.

The terminal 12B displays a message notifying download complete (B25). Accordingly, the client application 13B can edit or print the downloaded posted label data.

### (Printing Processing)

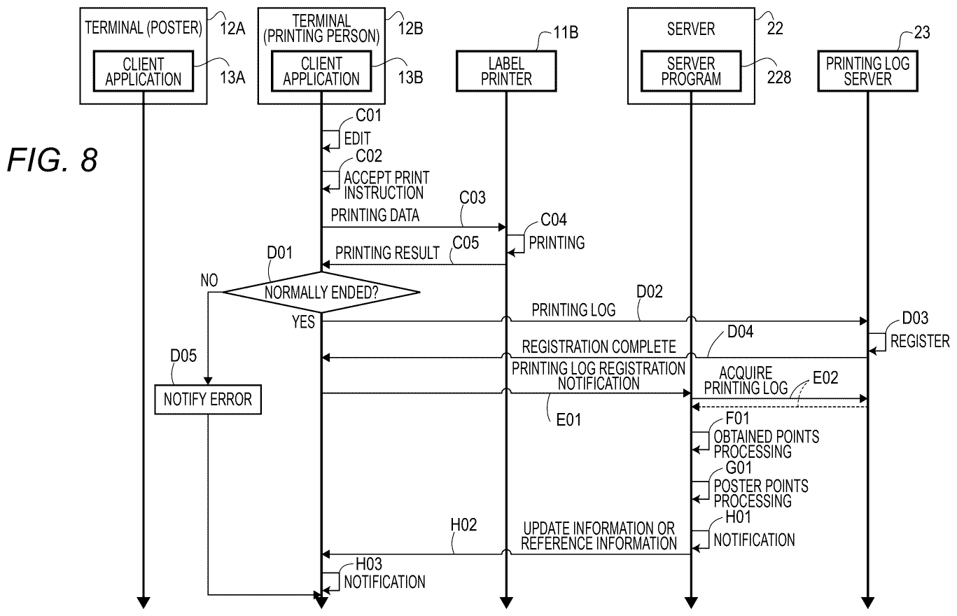

As illustrated in the sequence diagram of FIG. 8, in the printing processing, for example, the client application 13B of the terminal 12B edits the label data (C01) and accepts a print instruction (C02).

An example of editing the label data and inputting the print instruction will be described. For example, the client application 13B displays an edit screen for editing the label data. The edit screen includes, for example, an editing area for displaying image data on the label to be printed, a setting area (not illustrated) for setting various setting items for the label data, and a “print” button (not illustrated) for accepting the print instruction.

For example, upon accepting various settings in the setting area while the posted label data is displayed in the editing area of the edit screen, the client application 13B of the terminal 12B reflects the accepted settings in the posted label data. When the “print” button is tapped, the client application 13B accepts the print instruction (C02).

Upon accepting the print instruction, the client application 13B generates print data based on the posted label data edited on the edit screen and transmits the print data to the label printer 11B (C03). The label printer 11B prints a label based on the received print data (C04). When the printing of the label is ended, the label printer 11B transmits the printing result to the terminal 12B (C05).

Upon receiving the printing result from the label printer 11B, the terminal 12B determines whether the printing is normally ended based on the printing result (D01). When it is determined that the printing is not normally ended (D01: NO), the terminal 12B performs an error notification notifying that the printing failed (D05), and ends the process.

On the other hand, when it is determined that the printing is normally ended (D01: YES), the terminal 12B outputs the printing log based on the printing of the label (D02). The printing log output from the terminal 12B is received by the printing log server 23 and registered in the printing log DB 30 (D03).

Specifically, the printing log server 23 generates a new printing log ID and stores the new printing log ID in the printing log ID 301 of a new record. The printing log server 23 stores the user ID included in the received printing log, the tape model number of the tape used for printing, the label ID of the printed posted label data, the size information including the label length and the label width of the printed label, and the printing date and time when the label is printed, in the user ID 302, the tape model number 303, the label ID 304, the size information 305, and the printing date and time 306 of the new record, respectively.

After completing the registration of the printing log, the printing log server 23 notifies registration complete to the terminal 12B that transmitted the printing log (D04). The printing log ID assigned to the registered printing log is attached to the registration complete notification.

Upon receiving the notification of registration complete from the printing log server 23, the terminal 12B transmits a printing log registration notification to the label management server 22 (E01). The printing log ID attached to the registration complete notification is attached to the printing log registration notification. Upon receiving the printing log registration notification, the label management server 22 accesses the printing log server 23 using the network IF 225 and reads and acquires the printing log including the printing log ID attached to the registration complete notification from the printing log DB 30 (E02). The process of E02 is an example of “acquisition processing”.

Upon acquiring the printing log, the label management server 22 executes obtained points processing (F01). The obtained points processing is a process of granting points based on the length of the label to the printing person who prints the label.

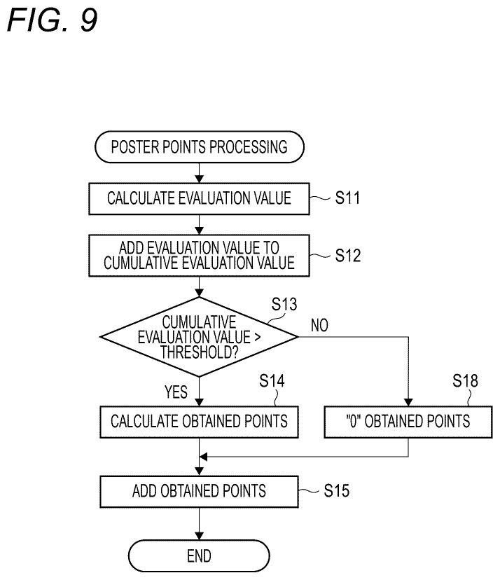

To describe the obtained points processing based on the flowchart of FIG. 9, the CPU 221 of the label management server 22 extracts the label length from the acquired printing log and calculates an evaluation value (S11). S11 is an example of “calculation processing”.

For example, upon receiving the printing log registration notification attached with a printing log ID “xxx03” from the terminal 12B, the CPU 221 passes the printing log ID to the printing log server 23. The printing log server 23 reads the printing log including the printing log ID “xxx03” from the printing log DB 30 illustrated in FIG. 5 and passes the printing log to the label management server 22. Upon receiving the printing log via the network IF 225, the CPU 221 of the label management server 22 reads a tape coefficient “1.1” corresponding to a tape model number “ccc1” included in the printing log from the tape metrics information 229 illustrated in FIG. 2. The CPU 221 calculates a temporary evaluation value based on a label length “9 cm” included in the size information of the printing log acquired from the printing log server 23, and multiplies the temporary evaluation value by the tape coefficient “1.1” to calculate the evaluation value.

The CPU 221 adds the evaluation value calculated in S11 to the cumulative evaluation value held by the printing person (S12). The S12 is an example of “evaluation value addition processing”.

For example, the CPU 221 accesses the user DB 25 illustrated in FIG. 3. The user DB 25 indicates a state before the main printing. CPU 221 extracts a user ID “aaa2” from the printing log of the printing log ID “xxx03” acquired from the printing log DB 30, adds the evaluation value calculated in S11 to a cumulative evaluation value “900” associated with the user ID “aaa2”, and updates the cumulative evaluation value.

The CPU 221 determines whether the cumulative evaluation value after the evaluation value is added in S12 is larger than a threshold (S13). Here, the threshold is set to “1000” and “1” points can be obtained for each cumulative evaluation value “1000”.

For example, when the cumulative evaluation value after the addition is “1010” and exceeds the threshold “1000” (S13: YES), the CPU 221 calculates the obtained points “1” (S14). That is, the printing person can obtain “1” points. “1” obtained points is an example of a “first value”. In this case, the CPU 221 subtracts the cumulative evaluation value “1000” necessary for obtaining “1” points from the cumulative evaluation value “1010” after the addition, and updates the cumulative evaluation value to “10”. Accordingly, the obtained points can be prevented from being doubly granted to the printing person. For example, when “2” points are obtained in S12, CPU 221 subtracts “2000” from the cumulative evaluation value after addition in S12. When points are obtained, the cumulative evaluation value may be reset.

On the other hand, for example, when the cumulative evaluation value after the addition is “990” and does not exceed the threshold “1000” (S13: NO), the CPU 221 determines “0” as the obtained points (S18). That is, the printing person cannot obtain points. In this case, the CPU 221 maintains, without updating, the cumulative evaluation value after the addition. The threshold and the criterion for granting the obtained points may be different from those in the present embodiment. The processing of S13, S14, and S18 is an example of “determination processing”.

The CPU 221 adds the obtained points to the held points of the printing person (S15). The S15 is an example of “addition processing”.

For example, when the cumulative evaluation value exceeds the threshold in S12 and points are obtained (S14), the CPU 221 accesses the user DB 25 illustrated in FIG. 3, adds the points obtained in S14 to points information “hhh2” corresponding to the user ID “aaa2” included in the printing log, and updates the held points. The CPU 221 updates the points update date and time associated with the user ID “aaa2” of the user DB 25, based on the date and time when the held points are updated.

On the other hand, when the cumulative evaluation value does not exceed the threshold in S12 and points cannot be obtained (S18), the CPU 11 cannot add the points to the held points and does not update the held points. In this case, the CPU 221 updates the points update date and time associated with the user ID “aaa2” of the user DB 25, based on the date and time when the cumulative evaluation value is updated.

Here, the points are added based on the cumulative evaluation value. The cumulative evaluation value is a value based on the length of the label. Therefore, more held points are added for a longer printed label. Therefore, the printing person can obtain points suitable for the consumption amount of the tape.

The cumulative evaluation value is a value obtained by accumulating label lengths. Therefore, the held points are also added when printing a label while replacing the tape. Therefore, the printing person can obtain points suitable for the consumption amount of the tape regardless of the type of the tape.

The points are determined using the tape coefficient. The tape coefficient is set higher for a more valuable tape, for example, a tape having a larger tape width, a special color, or subjected to special processing. Therefore, higher points are added to the held points by using a valuable tape even if the length of the label to be printed is the same. Therefore, the printing person can obtain points suitable for the value of the tape, that is, the printing cost. As a result, an increase in the motivation to use a more valuable tape is expected.

When the label management server 22 performs the process of S15 and ends the obtained points processing illustrated in FIG. 9, the process proceeds to poster points processing of G01 in FIG. 8. The poster points processing is a process of, when a label based on the posted label data is printed, granting points based on the label length of the label to the poster who has posted the posted label data.

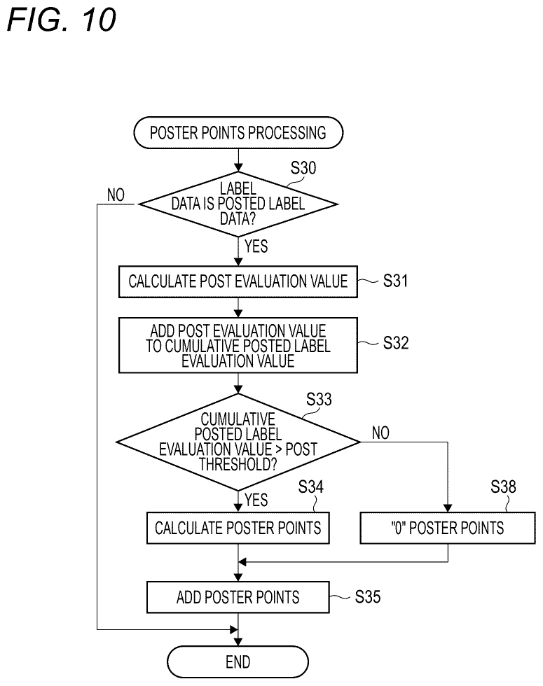

The poster points processing will be described with reference to the flowchart of FIG. 10. The CPU 221 of the label management server 22 determines whether the label data of the printed label is posted label data (S30). For example, when the acquired printing log does not include a label ID, the CPU 221 determines that the label data of the printed label is original label data, that is, not posted label data (S30: NO), and ends the poster points processing.

On the other hand, for example, when the printing log includes a label ID, CPU 221 determines that the label data of the printed label is posted label data (S30: YES), and S31 of calculating the post evaluation value (S31) is an example of “post calculation processing”.

For example, the printing log including the printing log ID “xxx03” acquired by the label management server 22 includes the label length “9 cm” in the size information. The CPU 221 calculates the post evaluation value based on the label length “9 cm”.

The CPU 221 adds the post evaluation value calculated in S31 to the cumulative posted label evaluation value held by the poster (S32). The S32 is an example of “post evaluation value addition processing”.

For example, the CPU 221 accesses the posted label DB 26 illustrated in FIG. 4. FIG. 4 illustrates a state before the main printing. For example, the CPU 221 adds the post evaluation value calculated in S31 to a cumulative posted label evaluation value “9970” associated with a label ID “ddd1” included in the printing log corresponding to the acquired printing log ID “xxx03”. As a result, the cumulative posted label evaluation value of the printed posted label data is updated.

The CPU 221 determines whether the cumulative posted label evaluation value calculated in S32 is larger than a post threshold (S33). Here, the post threshold is set to “10000” and the “1” poster points can be obtained for each cumulative posted label evaluation value “10000”.

For example, if the cumulative posted label evaluation value after the addition is “10007” and exceeds the threshold “10000” (S33: YES), the CPU 221 calculates the poster points “1” (S34). That is, the poster can obtain “1” poster points. “1” points is an example of a “second value”. In this case, the CPU 221 subtracts the cumulative evaluation value “10000” necessary for obtaining “1” poster points from the cumulative posted label evaluation value “10007” after the addition, and updates the cumulative posted label evaluation value to “7”. Accordingly, the poster points can be prevented from being doubly granted to the poster. For example, when “2” poster points are obtained, the CPU 221 subtracts “20000” from the cumulative posted label evaluation value after the addition. When poster points are obtained, the cumulative posted label evaluation value may be reset.

On the other hand, for example, when the cumulative posted label evaluation value after the addition is “9999” and does not exceed the threshold “10000” (S13: NO), the CPU 221 determines “0” as the poster points (S38). That is, the poster cannot obtain poster points. In this case, the CPU 221 maintains, without updating, the cumulative posted label evaluation value after the addition. The post threshold and the criterion for granting the poster points may be different from those in the present embodiment. The processing of S33, S34, and S38 is an example of “post determination processing”.

The CPU 221 adds the determined poster points to the held points of the poster (S35). The S35 is an example of “post addition processing”.

For example, the CPU 221 accesses the posted label DB 26 illustrated in FIG. 4 and reads a user ID (creator) “aaa1” corresponding to the label ID “ddd1” included in the acquired printing log. The CPU 221 accesses the user DB 25 illustrated in FIG. 3, adds the poster points calculated in S34 to points information “hhh1” associated with the user ID (creator) “aaa1”, and updates the held points of the poster. The CPU 221 updates the points update date and time associated with the user ID (creator) “aaa1” based on the update date and time of the held points.

On the other hand, when the cumulative posted label evaluation value after the addition is equal to or less than the post threshold, “0” poster points calculated in S36 is added to the points information “hhh1”. In this case, the held points are not changed or updated. The CPU 221 does not update the points update date and time associated with the user ID (creator) “aaa1”.

Here, the poster points are added based on the cumulative posted label evaluation value. The cumulative posted label evaluation value is calculated based on the label length of the label obtained by printing the posted label data. Therefore, more points are added to the poster for a printed label having a larger label length based on the posted label data. Therefore, the poster can obtain points suitable for the consumption amount of the tape consumed by printing the label data posted by the poster. Further, since the poster can obtain points by printing of another person, collection of meaningful posted label data can be expected in the label management server 22.

The tape coefficient may be used when determining the poster points. For example, the post evaluation value may be calculated by multiplying a temporary post evaluation value based on the tape length by the tape coefficient. In this case, higher points for the poster is added for a more valuable tape used for printing the posted label data. Therefore, the poster can obtain points suitable for the type of the tape.

When the label management server 22 performs the process of S35 and ends the post points processing illustrated in FIG. 10, the process proceeds to the notification of H01 in FIG. 8. The notification is a process of notifying the user of a reference of the print amount necessary for updating the held points or obtaining the points.

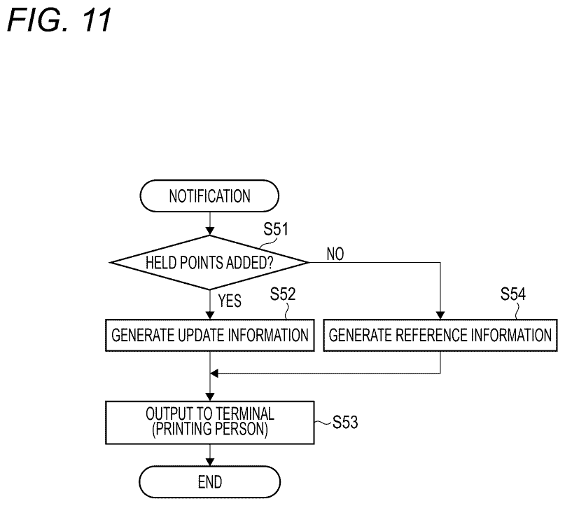

The notification processing will be described with reference to a flowchart of FIG. 11. The CPU 221 of the label management server 22 determines whether the held points have been added (S51). For example, when the held points are added in S15 of FIG. 9 (S51: YES), CPU 221 generates update information indicating that the held points are updated (S52). The CPU 221 outputs notification including the generated update information to the terminal 12B as the recipient (S53), and ends the notification. S52 and S53 are an example of “first notification processing”.

On the other hand, when the obtained points calculated in S14 of FIG. 9 is “0” and no held points are added in S15 (S51: NO), CPU 221 generates the reference information (S54). The reference information is, for example, information indicating the print amount or label length remaining until the cumulative evaluation value exceeds the threshold. The reference information may be the print amount remaining when the tape used in the current printing is reused, or may be a list of remaining print amounts for each type of tape. Alternatively, the reference information may be a length necessary for obtaining the points regardless of the tape. The CPU 221 outputs notification including the generated reference information to the terminal 12B as the recipient after the terminal 12B outputs the printing log (S53), and ends the notification processing. S54 and S53 are an example of “second notification processing”.

As illustrated in FIG. 8, the terminal 12B displays the update information or the reference information received from the label management server 22 (H02 and H03). This display may include a message notifying that the printing succeeded.

The label management server 22 may register the notification recipient corresponding to the user ID 251 registered in the user DB 25 in a push server, and push the notification of the update information and the reference information to the terminal 12B via the push server.

As described above, in the system 100 according to the present embodiment, the label management server 22 installed with the server program 228 acquires the printing log related to the printing in the label printer 11B. The label management server 22 determines the obtained points based on the label length of the printed label included in the acquired printing log. The obtained points are determined such that points are easier to obtain for a longer label. The label management server 22 adds the determined obtained points to the held points of the user who instructed the printing. As a result, the label management server 22 can grant the user appropriate points according to the consumption amount of the tape.

### Second Embodiment

Next, a data sharing system according to a second embodiment will be described. The second embodiment executes a process of printing log acquisition, obtained points processing, poster points processing, and notification at any set timing. This is different from the first embodiment in which these processes are performed each time the terminal 12B outputs the printing log, and the other points are common to the first embodiment. Hereinafter, differences from the first embodiment will be mainly described, and configurations and processes common to the first embodiment will be denoted by the same reference signs as the first embodiment, and description thereof will be omitted as appropriate.

For example, the administrator of the label management server 22 can use the operation display unit 226 to freely set the timing of acquiring the printing log, determining the obtained points, and adding the obtained points, such as the beginning of the month or the end of the month. The timing may be set for each user, or may be set in the label management server 22 by the user from the terminal 12.

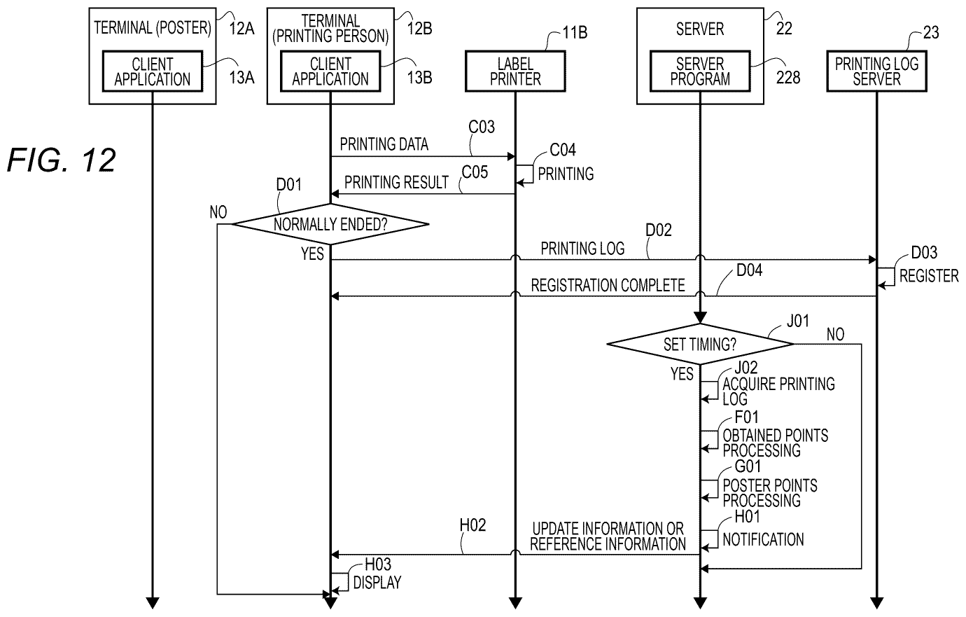

As illustrated in the sequence diagram of FIG. 12, the label management server 22 determines whether it is the set timing (J01). The processing of J01 is illustrated after the registration of the printing log in FIG. 12, but the processing of J01 may be performed at any timing regardless of printing, such as 0 a.m.

When it is the set timing (J01: YES), the label management server 22 accesses the printing log DB 30 of the user printing log server 23 and collectively acquires the printing logs corresponding to the period from the previous timing to the current timing (J02). For example, if the timing is set at the end of the month, the label management server 22 collectively acquires printing logs from 0:00 am on the first of the month to 23:59 on the last day of the month. Then, the label management server 22 performs the obtained points processing of F01 for each acquired printing log and updates the held points of each printing person (F01). The label management server 22 executes the poster points processing of G01 for each printing log, and updates the held points of each poster (G01). Then, the label management server 22 performs the update or the notification of the reference information according to the update status of the held points of each printing person (H01 to H03), and if it is not the set timing (J01: NO), the label management server 22 does not perform the processing starting from J02.

Therefore, in the second embodiment, since the obtained points are determined by collectively reading the printing logs at any timing, the processing load of the label management server 22 is smaller than in the first embodiment in which the obtained points are determined for each printing.

The embodiments disclosed in the present specification are merely an example, and does not limit the present invention. Therefore, various improvements and modifications can be naturally made to the technique disclosed in the present specification without departing from the gist of the present invention. The number of label printers 11 connected to the terminal 12 is not limited to the illustrated example, and may be two or more.

The tape coefficient may not be used to calculate the evaluation value of the S11 in FIG. 9. However, by calculating the evaluation value using the tape coefficient, the easiness of obtaining points differs based on the type of the tape included in the printing. Accordingly, the printing person can be expected to mount an expensive tape, which can easily obtain an evaluation value, on the label printer to print the label.

The processing of D01 to D04 and E01 to E02 in FIG. 8 may be omitted, and the label management server 22 may directly acquire the printing log from the terminal 12B. However, the printing log is once registered in the printing log DB 30, and the label management server 22 reads the printing log from the printing log DB 30, so that the obtained points can be determined at any timing. Such system can be used if there is an existing system for collecting printing logs.

The processing of S12 and S13 in FIG. 9 may be omitted, and the obtained points may be determined by only one evaluation value. However, by adding the evaluation value calculated based on the label length to the cumulative evaluation value and granting points when the cumulative evaluation value exceeds the threshold, points are also granted to a printing person who performs printing according to the cumulative print amount if, for example, short labels are printed continuously. Therefore, the user can obtain appropriate points according to the consumption amount of consumables.

The processing of H01 to H03 in FIG. 8 may be omitted, and the terminal 12B may not be notified of the update information. However, by the label management server 22 notifying the terminal 12B of the update information, the user can immediately understand that the held points have been added. Accordingly, an increase in the motivation of the user to print the next label can be expected. If there is a registration notification of the printing log from the terminal 12B, the label management server 22 may notify the update information as a response to the registration notification.

The processing of H01 to H03 in FIG. 8 may be omitted, and the terminal 12B may not be notified of the reference information. However, by the label management server 22 notifying the terminal 12B of the reference information, an increase in the motivation of the user to print the next label can be expected.

The reference information may also be notified when held points are added. However, some users may feel annoyed if the reference information is also notified when points are added. Therefore, by notifying the reference information when no points are added and not notifying the reference information when points are added, it is possible to limit the notification frequency of the reference information.

The poster points processing of G01 in FIG. 8 may be omitted. However, by granting post points based on the label length of the printed label to the poster of the posted label data when a label based on the posted label data is printed by the label printer 11B, it is also possible to grant the poster appropriate points according to the consumption amount of consumables.

The poster points granted to the poster may be the same as the points granted to the printing person, or may be several percent of the points granted to the printing person.

In the printing of posted label data, the poster points may be set higher or the post evaluation value may be set higher than the printing of original label data, which is not posted label data, so that the poster can easily obtain points.

If poster points are added to the held points in S35 of FIG. 10, the poster may be notified that the held points have been updated.

The label management server 22 may include a front-end server having a web server function and a back-end server having a function different from the web server function. For example, the front-end server accepts access from the terminal 12 and stores the posted label data in the posted label DB 26 in association with the user ID. For example, the back-end server accesses various databases and performs processing for handling evaluation values and points. The exchange of points with the terminal 12 may be performed by cooperation between the back-end server and the front end server.

In any sequence diagram disclosed in the embodiments, an execution order of any plurality of processes can be freely changed or can be executed in parallel within a range in which no contradiction occurs in a processing content.

The processes disclosed in the embodiments may be executed by hardware such as a single CPU, a plurality of CPUs, and an ASIC, or a combination thereof. In addition, the processes disclosed in the embodiments can be implemented in various modes such as a recording medium in which a program for executing the processes is recorded, or a method.

What is claimed is:

1. A non-transitory computer readable storage medium storing a program configured to be executed by a server,
the server being configured to access a points database storing held points for each user ID,
the held points being points held by a user,
the program comprising instructions which, when executed by the server, cause a computer of the server to execute:
acquisition processing of acquiring a printing log, the print log being output from an information processing device in a case where the information processing device causes a label printer to print, the printing log including a user ID set in the information processing device and a length of a printed label, and
wherein the instructions further cause the computer of the server to execute:
determination processing of determining obtained points such that points are easier to obtain for a longer label, based on the length of the label included in the printing log acquired in the acquisition processing, the obtained points being points to be granted by printing with the label printer; and
addition processing of accessing the points database to add the obtained points determined in the determination processing to the held points corresponding to the user ID included in the read printing log.

2. The non-transitory computer readable storage medium according to claim 1,
wherein the printing log includes a type of a printed tape, and
in the determination processing:
the obtained points are determined such that points are easier to obtain for a longer label, based on the length of the label included in the printing log acquired in the acquisition processing; and
easiness for obtaining points differs based on the type of tape included in the read printing log.

3. The non-transitory computer readable storage medium according to claim 1,
wherein the server is configured to access a printing log database, the printing log output by the information processing device is registered to the printing log database, and
in the acquisition processing, the computer is configured to access the printing log database to read the registered printing log and acquire the printing log.

4. The non-transitory computer readable storage medium according to claim 3,
wherein the instructions cause the computer of the server to execute the acquisition processing, the determination processing, and the addition processing at any set timing.

5. The non-transitory computer readable storage medium according to claim 1,
wherein the instructions cause the computer of the server to execute the acquisition processing, the determination processing, and the addition processing each time the printing log is output from the information processing device.

6. The non-transitory computer readable storage medium according to claim 1,
wherein in a case where the held points are added in the addition processing, the instructions cause the computer of the server to execute first notification processing of notifying the information processing device of an update of the held points, the information processing device outputting the printing log acquired in the acquisition processing.

7. The non-transitory computer readable storage medium according to claim 1,
wherein the server is configured to access a cumulative print amount database storing a cumulative evaluation value indicating a cumulative print amount for each user ID,
the instructions cause the computer of the server to execute:
calculation processing of calculating an evaluation value based on the length of the label included in the printing log acquired in the acquisition processing; and
evaluation value addition processing of accessing the cumulative print amount database to add the evaluation value calculated in the calculation processing to the cumulative evaluation value corresponding to the user ID included in the acquired printing log, and
in the determination processing:
in a case where the cumulative evaluation value added in the evaluation value addition processing exceeds a threshold, the obtained points are set to a first value; and
in a case where the cumulative evaluation value added in the evaluation value addition processing does not exceed the threshold, the obtained points are set to 0.

8. The non-transitory computer readable storage medium according to claim 7,
wherein after the execution of the determination processing, the instructions cause the computer of the server to execute a second notification processing of notifying the information processing device of reference information, the information processing device registering the printing log, the reference information indicating a print amount remaining until the cumulative evaluation value exceeds the threshold.

9. The non-transitory computer readable storage medium according to claim 8,
wherein after the execution of the determination processing, the instructions cause the computer of the server:
in a case where the held points are not added in the addition processing, to execute the second notification processing; and
in a case where the held points are added in the addition processing, not to execute the second notification.

10. The non-transitory computer readable storage medium according to claim 1,
wherein the instructions cause the computer of the server to execute:
upload acceptance processing of accepting a user ID and an upload instruction of label data from a first information processing device, the label data being data configured to be printed by the label printer,
in a case where the upload instruction for the label data is accepted in the upload acceptance, the instructions further causes the computer of the server to execute:
reception processing of receiving posted label data that is the label data uploaded from the first information processing device; and
storage processing of storing the posted label data received in the reception processing in association with the user ID accepted in the upload acceptance processing,
the instructions cause the computer of the server to execute download acceptance processing of accepting a download instruction of the posted label data from a second information processing device,
in a case where the download instruction of the posted label data from the second information processing device is accepted in the download acceptance processing, the instructions further cause the computer of the server to execute:
transmission processing of transmitting the posted label data to the second information processing device,
the server is configured to access a posted print amount database storing a cumulative posted label evaluation value indicating a cumulative print amount for each piece of the posted label data,
in a case where the printing log is output in response to the second information processing device causing the label printer to print the posted label data and the printing log due to the printing of the posted label data is acquired in the acquisition processing,
the instructions further cause the computer of the server to execute:
post calculation processing of calculating a post evaluation value based on a length of the label included in the printing log acquired in the acquisition processing;
post evaluation value addition processing of accessing the posted print amount database to add the post evaluation value calculated in the post calculation processing to the cumulative posted label evaluation value corresponding to the printed posted label data;
post determination processing of:
in a case where the cumulative posted label evaluation value added in the post evaluation value addition processing exceeds a post threshold, setting poster points granted by printing the posted label data to a second value; and
in a case where the cumulative posted label evaluation value added in the post evaluation value addition processing does not exceed the post threshold, setting the poster points to 0; and
post addition processing of accessing the points database to add the poster points determined in the post determination processing to the held points corresponding to the user ID associated with the printed posted label data.

11. A server for connecting to an information processing device via a network, the server being configured to access a points database storing held points for each user ID, the held points being points held by a user,
wherein the server executes:
acquisition processing of acquiring a printing log output from the information processing device in a case where the information processing device causes a label printer to print, the printing log including a user ID set in the information processing device and a length of a printed label, and
the server further executes:
determination processing of determining such that points are easier to obtain for a longer label, based on the length of the label included in the printing log acquired in the acquisition processing, the obtained points being points to be granted by printing with the label printer; and
addition processing of accessing the points database to add the obtained points determined in the determination processing to the held points corresponding to the user ID included in the read printing log.

12. A label data sharing system comprising:
a first information processing device;
a second information processing device; and
a server,
wherein the first information processing device and the second information processing device are configured to connect to the server via a network,
the server is configured to store label data in association with a user ID, the label data being data configured to be printed by a label printer,
the first information processing device is configured to upload posted label data to the server in association with the user ID input to the first information processing device, the posted label data being label data of the first information processing device,
the server is configured to store the posted label data uploaded from the first information processing device in association with the user ID associated with the uploaded posted label data,
the second information processing device is configured to download the posted label data stored in the server from the server,
in a case where the second information processing device causes a label printer to print the posted label data, the second information processing device outputs a printing log corresponding to the printing, the output printing log including the user ID set in the second information processing device and a length of a printed label,
the server is configured to access a points database storing held points for each user ID, the held points being points held by the user, and
the server is configured to execute:
acquisition processing of acquiring the printing log;
determination processing of determining obtained points such that points are easier to obtain for a longer label, based on the length of the label included in the printing log acquired in the acquisition processing, the obtained points being points granted by printing with the label printer; and
addition processing of accessing the points database to add the obtained points determined in the determination processing to the held points corresponding to the user ID set in the second information processing device.
